(19) United States
(12) Patent Application Publication
(10) Pub. No.: US 2026/0014536 A1
(43) Pub. Date: Jan. 15, 2026

(54) MULTI-PHASE FLUID HEATER FOR PYROLYTIC, CATALYTIC, AND GASIFICATION PROCESSES

(71) Applicants: Mark Ernest Blue, Snohomish, WA (US); Douglas Alexander Espin Altuve, Saarbruecken (DE); Myles Bradley Hebert, Melbourne, FL (US)

(72) Inventors: Mark Ernest Blue, Snohomish, WA (US); Douglas Alexander Espin Altuve, Saarbruecken (DE); Myles Bradley Hebert, Melbourne, FL (US)

(21) Appl. No.: 18/772,170

(22) Filed: Jul. 13, 2024

Related U.S. Application Data
(60) Provisional application No. 63/466,936, filed on May 16, 2023.

(51) Int. Cl. B01J 6/00; C10B 53/04; H05B 6/64

(52) U.S. Cl. CPC B01J 6/008; H05B 6/6491; C10B 53/04

(57) ABSTRACT

A system and method for heating fluid feedstocks for chemical production processes. The system and method uniformly heats feedstock fluids to the requisite temperatures needed to enable pyrolytic, gasification, and catalytic reactions.

### CROSS-REFERENCE TO RELATED APPLICATIONS

This application claims the benefit of U.S. Provisional patent application Ser. No. 63/466,936 filed May 16, 2023 and entitled MULTI-PHASE FLUID HEATER FOR PYROLYTIC, CATALYTIC, AND GASIFICATION PROCESSES.

### BACKGROUND OF THE INVENTION

Approximately 95% of global hydrogen production is produced from utilizing fossil fuel “feedstock”, by steam reforming of natural gas, other hydrocarbons, and coal gasification. Hydrogen is an important resource that is required globally for essential industrialized chemical processes. The current processes utilized by industry to heat feedstock are energy intensive and inefficient. The purpose of this invention is to provide a system and method to efficiently and uniformly heat fluid feedstocks for chemical production processes, but especially for hydrogen production processes.

The majority of current hydrogen production processes require feedstock inlet temperatures exceeding 400 degrees Celsius and for the feedstock temperature range to be maintained within a narrow operational temperature band. There are extant hydrogen production devices, as well as others under development, that face operational limitations due to constraints attributed to the feedstock heating processes. Traditional thermal convection and conduction heat transfer mechanisms, though common and well known, have limited temperature ranges, suffer significant hysteresis in temperature response times, and require large operational surface areas and volumes which incur large capital costs for both equipment and facilities. Furthermore, many traditional heat transfer methodologies are carbon intensive and operate at lower thermal efficiencies than electromagnetic heating methods. Additionally, the energy efficiency of the prior art has been highly dependent on fluid flow rates. Prior art devices have required that the heat source and the heat transfer utilize two separate pieces of equipment, requiring extra burners that use gas or oil emitting green house gases. Furthermore, the prior art often requires overheating of input fluids to withstand temperature losses during travel through prior art devices.

### SUMMARY OF THE INVENTION

The present invention is a system and method to uniformly heat feedstock fluids, such as ammonia, coal dust, or any hydrogen containing material, to temperatures needed to enable pyrolytic, gasification and/or catalytic reactions in industrial uses, including the decomposition of hydrocarbons and carrier molecules used in the transportation of hydrogen, utilizing electromagnetic heating with power, frequency bands, and susceptor selected for purpose (not simply microwave band).

The present invention accomplishes the desired goal of efficiently heating feedstock for the production of hydrogen; by utilizing a unique combination of electromagnetic (EM) radiative heating in combination with a susceptor material in the form of a fluidized bed and flow mixing, the proposed system and method can provide scalable fluid flows at temperatures between 200 and 1200 degrees Celsius and maintain the desired operational temperature within a small operating range due to the near instantaneous response time in the present invention's radiative heat transfer system.

Relative to conductive and convective heat transfer systems, the present invention's usage of EM radiative heating with power, frequency bands, and susceptor selected for purpose (not simply microwave band) facilitates smaller facility sizes and equipment lifecycle costs as well as increased production rates. The reduction in capital costs and the increase in energy transfer efficiency can reduce the overall lifetime cost of chemical production, especially hydrogen production, which will accelerate market adoption and distribution of hydrogen-based technologies across a hydrogen-based economy.

In the preferred embodiment of the present invention, sustained feedstock flows and temperature are utilized within a small operating envelope with near real time response to changes in system operations. This increases production rates and efficiencies in a variety of generation processes, including but not limited to pyrolysis, gasification, and catalytic reactions. The preferred embodiment of the present invention allows for sustained process flows at temperatures between 400 degrees Celsius to 600 degrees Celsius for most hydrogen generation processes, but the present invention allows for temperature ranges from 100 degrees Celsius to 1200 degrees Celsius depending on the use case and build materials of the system.

In an alternative embodiment, instead of being attached to a traditional energy grid, the system and method can incorporate a renewable energy system/grid and reduce or eliminate greenhouse gas emissions from the feedstock heating process phase of the production process eliminating carbon pollution from the production process.

The present invention's use of EM radiative heating allows a user to maintain a small operational temperature range necessary for process optimization (e.g. pyrolysis, gasification, and catalytic reactions) due to the rapid energy transfer rate responses capable in electrically based systems, and allows for the system's heat source and the heat transfer mechanism to exist within the same device. The rapid energy transfer rate responses allow for a substantial increase in response time over the prior art, i.e., when there is a change in the system state, for example flow rate or temperature change requirement, prior art conduction and convection heating systems are substantially slower to adjust than the present invention. The present invention is also substantially quicker to achieve an operational temperature from a cold start as compared to prior art devices due to the use of EM radiative heating of the susceptor pack. Importantly, the heat of the fluid within the device, because of the susceptor components packing, the use of a turbulator, optional use of internal baffles within the susceptor pack, and use of RF energy for radiative heating is homogeneous, unlike the prior art where the system heat is necessarily higher in the walls of prior art devices to withstand thermal losses which requires higher energy, increased waste, and increased environmental impact.

The preferred embodiment is scalable from laboratory to industrial flow rates and will reduce lifecycle costs in both equipment and facilities.

### BRIEF DESCRIPTION OF DRAWINGS

FIG. 1 is an illustration showing a longitudinal cut-out perspective of the system in accordance with one embodiment of the present invention.

FIG. 2 is an illustration showing a cross section of the heating cavity and susceptor pack.

FIG. 3 is an illustration showing a magnification of the cross section of the susceptor pack.

### DETAILED DESCRIPTION OF THE INVENTION

In the following description, numerous specific details are set forth in order to provide a thorough understanding of the present invention. It will be apparent, however, to one skilled in the art that the present invention may be practiced without some of these specific details. In other instances, well known process operations have not been described in detail in order not to unnecessarily obscure the present invention.

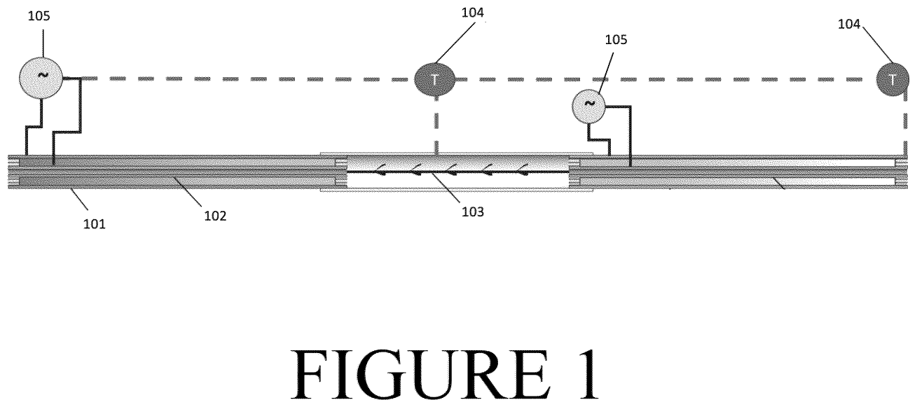

The invention comprises the following key features shown on FIG. 1: the cut-out tube that is indicated by 101 is the outer wall of a coaxial resonant cavity/heating cavity, 102 is the inner wall of the coaxial resonant cavity/heating cavity, 103 is a turbulator, 104 is a temperature sensor and flow detector, and 105 is the electromagnetic signal input.

In the preferred embodiment, fluid is supplied to an intake and into a resonant coaxial transmission line, which can be selected from one of any resonant cavity geometries, wherein fluid flows between the inner and outer conductors. An electromagnetic generator is connected to the inner and outer conductors to provide an appropriate frequency and power, said frequency ranging between 100 kilohertz and 1 gigahertz and said power ranging from the kilowatt to megawatt range, depending on the size, mass flow rate, and target temperatures. The frequency and power of the electromagnetic generator are selected based on the input fluid and desired output. In the preferred embodiment the susceptor components are contained within the same annulus the fluid is flowing; between the inner and outer conductor. The electromagnetic field is formed within the annulus from the electromagnetic wave running between the inner and outer conductor. Energy is transferred from the field to the susceptor material and thus the EM field heats the susceptor material to the desired temperature for the user's application through radiative heat transfer. In the preferred embodiment, the flow path is packed with susceptor components, the susceptor component material sized in a way to create high permeability in the annulus which allows the process fluid (liquid and/or gas) to flow through the device and interact with the susceptor components. The heated susceptor components transfers the absorbed energy from the radiative heating process to the fluid flowing through the annulus via both conduction and convective heat transfer. The susceptor component material geometry is selected based on desired fluid flow rates and heat transfer requirements, to enable a large heat transfer surface area for rapid changes in energy transfer within the system. The preferred susceptor geometry is spherical or spheroid, although alternative embodiments of the form or approximating the form of a n-sided polyhedron could also be used. As the input fluid passes through the heating cavity, in a preferred embodiment the fluid is passed through or around a turbulator to ensure complete mixing of the fluid and a homogeneous/isothermal temperature profile. Additional stages to the process, for example branching off of an initial heating cavity or turbulation cavity into subsequent chambers, in series or parallel depending on the input fluid and desired output, may be added for several purposes, for example providing a catalyst to input fluid or products therefrom, allowing for outflows, or for further heating or turbulation of inputs, products, or byproducts as required. FIG. 1 shows a heating cavity, then a turbulator, followed by another heating cavity. The diameter of the system can range from a few inches to five or more feet and is only limited by the power required to create the electromagnetic field and the specific use case of the system.

In a preferred embodiment, temperature and flow sensors provide feedback to the control system to enable continuous monitoring of system temperatures and rapid responses to system dynamic behaviors, although alternative embodiments utilizing only a temperature or only flow sensors could be used.

An EM power supply provides energy to the resonant cavity/heating cavity/transmission line and creates an EM field within the heating cavity. The susceptor components in the annulus of the device interact with the EM fields and are thereby radiatively heated. The susceptor components in the heating cavity absorb EM energy and increase to a targeted operational temperature depending on the use-case. The susceptor components transfer heat to fluid entering the system via both convection and conduction.

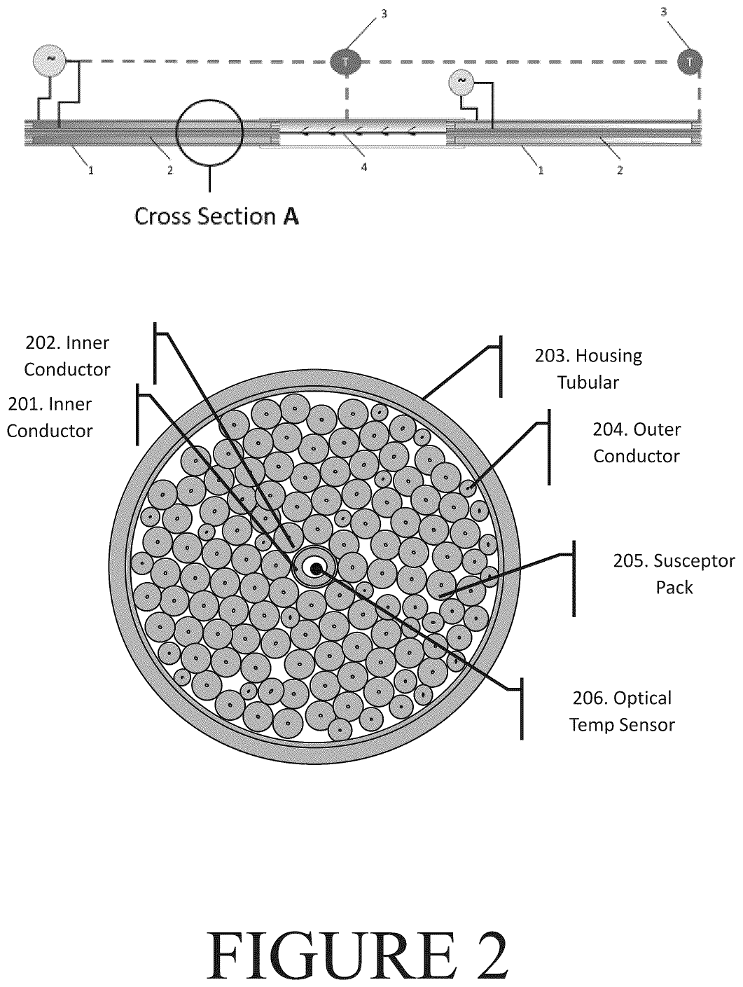

In the preferred embodiment, after the fluid moves through the susceptor pack shown in FIG. 2, the fluid, which should be homogenous or nearly homogeneous in temperature after moving through the susceptor pack and being heated via conduction and convection, transitions into the turbulator chamber, 103, for continued fluid mixing to ensure temperature homogeneity. After the turbulator chamber the fluid moves to either an outlet valve to discharge all or part of the fluid, another heating chamber, another turbulation chamber, or a catalytic chamber. The chambers can be chained together in series or in parallel. An alternative embodiment a fluid would first move through a heating chamber before branching off either in series or parallel into subsequent chambers (outlet valve, another heating chamber, or catalytic chamber) before turbulation.

The preferred embodiment of the present invention allows for expansion into a multi stage system. The preferred embodiment can be configured from one to n stages, where n is a whole number, in series, series parallel, or parallel configurations depending on the application. The size of a multi-stage system would only be limited by application need and space availability. In the multi-stage system, the outflow from one stage would be sent, in whole or in part, to the inflow of a subsequent stage, wherein the fluid could be passed through an additional heating cavity, turbulator, or a chamber in which a catalyzing material is present in order to further react the input fluid or products therefrom, before moving to the outflow as either a final product or on to another subsequent stage as an intermediate product. The use of multiple stages allows for additional mixing which increases homogeneity of the fluid's properties. The combination used in each case will be dependent on the specific use case.

The design of the preferred embodiment of the invention is comprised of simple tubulars, flanged together into a system subassembly. In a preferred embodiment, the flanges of the device are mechanically coupled in such a way as to prevent electromagnetic leakage.

FIG. 2 depicts a cross section of the device, comprising: 201 is the interior component of the inner conductor structural member, 202 is the exterior component of the inner structural member, 203 is the housing tubular or exterior component of the outer conductor structural member, 204 is the interior component of the outer conductor structural member, 205 indicates the susceptor pack, and 206 is the fiber optic temperature sensor.

In the preferred embodiment, the interior component of the inner conductor structural member 201 is made from stainless steel, although metals with similar physical properties could be utilized. Also in the preferred embodiment, the exterior component of the outer conductor structural member 202 is made from copper or a hydroformed copper sleeve, although a metal with similar physical properties could also be used. Interior component 201 and exterior component 202 are adhered or bonded to each other. The use of stainless steel as the inner conductor structural member provides structural stability to the device. Similarly, the exterior component of the housing tubular or exterior component of the outer conductor structural member is also preferably stainless steel, which provides both electromagnetic shielding as well as being appropriate to handle the temperatures inside the device without device degradation. The thickness of the stainless steel or alternative material is variable but chosen, in part, based on the expected pressure of the fluid. The interior component of the housing tubular or interior component of the outer conductor structural member is preferably copper or a hydroformed copper sleeve, although a metal with similar physical properties could also be used. Because of the material selected for the housing tubular or outer conductor structural member and the materials selected for the inner conductor structural member, the device is shielded from exterior EM penetration and the environment in which the device operates is shielded from electromagnetic radiation emanating from the interior of the device. The thickness of the copper, hydroformed copper sleeve, or alternative material is variable but chosen, in part, based on the skin depth of the chosen frequency being utilized.

Item 205 in FIG. 2 shows an embodiment of the pack of susceptor components. Each susceptor component, represented in FIG. 2 by circles lying between housing tubular 203 and exterior component of the inner conductor structural member, can be sized as small as 1/64th of an inch in diameter to 1 inch in diameter. The susceptor components are preferably spherical to maximize permeability and pore space in the susceptor pack, although other shapes could be utilized. The susceptor component diameter, which determines the susceptor surface area, is selected depending on the fluid that has been placed into the device. A smaller diameter susceptor results in a lower fluid flow rate. This in turn allows the fluid to interact with the device for longer and absorb additional thermal energy and thus become hotter. Likewise, a large diameter susceptor results in larger gaps between the susceptor components and thus a higher flow rate. In the preferred embodiment, the susceptor components are of a similar diameter, within a 100% variation in diameter size. A key distinction between the present invention and the prior art is the present invention's ability to provide uniform heat throughout the heating cavity. Normally, when you provide heat to a fluid you are heating the walls of a container, and heat is being transferred from the walls into the fluid and heat slowly spreads from the outside of the volume of fluid to the inside of the fluid. With the present invention's susceptor component configuration and susceptor heating, heat is able to be evenly and simultaneously delivered to the fluid as the volume enters the cavity, reducing both the total energy required to heat the fluid, avoids excessively heating the exterior of the fluid, and reduces the total time needed to heat the fluid.

Fiber optic temperature sensor 206 runs through the device and detects the temperature of the interior component of the inner conductor structural member, from which the temperature of fluids inside the system can be determined.

In a preferred embodiment, materials are selected for the housing tubular or exterior component of the outer conductor structural member and for the interior component of the inner conductor structural member such that, combined with mechanical connections/flanges at the input and output of the device, a Faraday cage is created preventing EM leakage or unwanted EM penetration into the device.

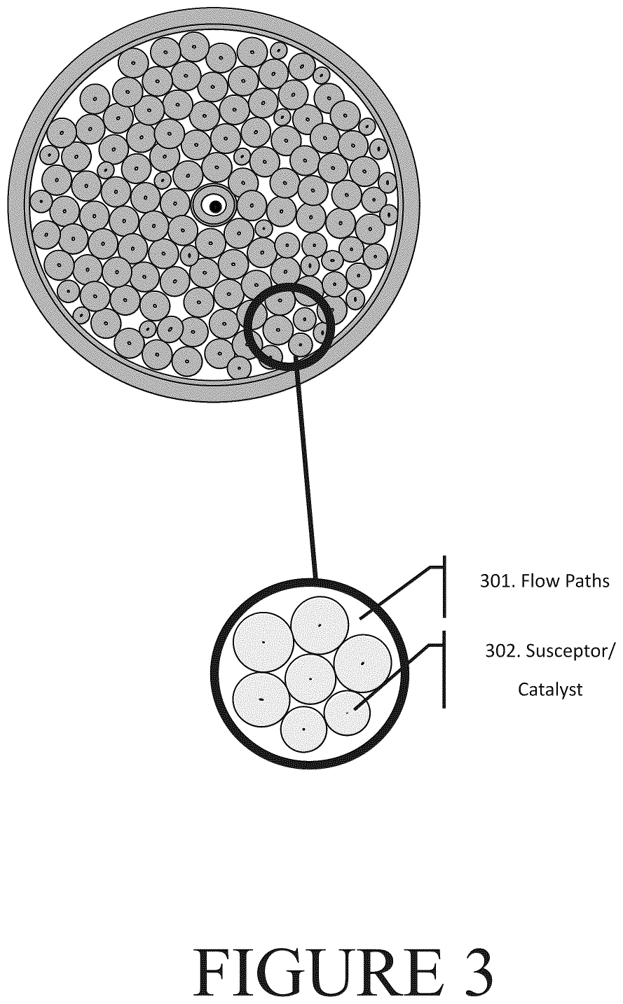

FIG. 3 shows a magnified section of the susceptor component pack with cross sectioned susceptor components. 301 indicates the space in the device through which fluid flows. 302 is one of a plurality of susceptor components distributed throughout the heating cavity of the device. In a preferred embodiment, the susceptor is made of a uniform material that is a photo responsive material or electromagnetically reactive material. Specifically, material for the susceptor is selected for the materials ability to increase in temperature when exposed to an electromagnetic field, that is, for the material's ability to be radiatively heated by EM. One of the preferred materials for the uniform susceptor is iron or iron-based compounds or composites. Rubidium, nickel, carbon, and cobalt, as well as their compounds or composites, are also potential susceptor materials. In an alternative embodiment, a catalyzing material can be used on the surface of the susceptor component, so as to react with the fluid.

The EM field created by the electromagnetic generator interacts with the susceptor components, causing said components to increase in temperature via radiative heat transfer to the susceptor components. The use of radiative heat transfer was chosen over magnetic induction heating for a number of reasons, but primarily, magnetic induction heating was avoided because of its inability to operate efficiently at the preferred temperature ranges of the present invention (100 to 1200 degrees Centigrade). The EM generator is calibrated to produce an EM field that, when interacting with susceptor components selected from appropriate material, creates the desired temperature range to breakdown the target fluid inserted into the device via the device inlet.

While this invention has been described in terms of several embodiments, it will be appreciated that those skilled in the art upon reading the preceding specifications and studying the drawings will realize various alterations, additions, permutations, and equivalents thereof. Therefore, it is intended that the present invention includes all such alterations, additions, permutations, and equivalents as fall within the true spirit and scope of the invention.

1. A system and method to heat fluids to pyrolytic temperatures comprising:
a. catalytic susceptors of electromagnetic energy
b. one or more coaxial resonant cavities formed by one or more coaxial structures
c. a turbulator
d. a temperature sensor
e. a flow detector
f. an electromagnetic input
g. one or more fluid input valves
h. one or more fluid outlet valves.

2. The catalytic susceptors of claim 1, wherein the catalytic susceptors are iron based.

3. The frequency of the electromagnetic input of claim 1 ranging from 100 kilohertz to 1 gigahertz.

4. The power of the electromagnetic input of claim 1 ranging from 1 kilowatt to 999 megawatts.

5. The fluid of claim 1 being any hydrogen containing material.

6. The susceptors of claim 1 wherein the susceptors rest in the annuli of the one or more coaxial cavities.

7. The internal operational temperature of the system and method of claim 1 ranging from 100 degrees Celsius to 1200 degrees Celsius.

8. The system and method of claim 1 wherein the one or more coaxial resonant cavities is terminated on the ends of the annuli with a metal mesh.

9. The one or more coaxial resonant cavities of claim 1 formed by the annuli between the one or more coaxial structures.
